(19) United States
(12) Patent Application Publication
(10) Pub. No.: US 2010/0044244 A1
(43) Pub. Date: Feb. 25, 2010

(54) DEIONIZATION APPARATUS AND METHOD OF CONTROLLING THE SAME

(75) Inventors: Won Kyoung LEE, Suwon-si (KR); Seon Jk Na, Yongin-si (KR); Sang Joon Lee, Gwacheon-si (KR); Dae Woos Park, Hwaseong-si (KR); Tai Eun Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/469,057

(22) Filed: May 20, 2009

(30) Foreign Application Priority Data
Aug. 22, 2008 (KR) 10-2008-82174

(51) Int. Cl. B01D 61/54; B01D 61/50

(52) U.S. Cl. 205/687; 204/267

(57) ABSTRACT

A regeneration method to rapidly and efficiently desorb ions after the ions are absorbed to electrodes in a deionization apparatus to eliminate ion components in a fluid (liquid and gas) is disclosed. A plurality of cells including a plurality of electrodes to absorb ions included in a fluid are connected to configure a stack. In a capacitive deionization (CDI) apparatus including at least two stacks, if 0 V is applied as a method of desorbing the ions and regenerating the electrodes after the ions are absorbed to the electrodes, and the cells or the stacks are connected in series in a state in which the cell units and the stack units obtained by connecting the cells are electrically disconnected from a power source, the capacitance of the entire system is reduced, a discharging time is shortened, and the ions are rapidly and efficiently desorbed.

### CROSS-REFERENCE TO RELATED APPLICATIONS

This application claims the benefit of Korean Patent Application No. 2008-82174, filed on Aug. 22, 2008 in the Korean Intellectual Property Office, the disclosure of which is incorporated herein by reference.

### BACKGROUND

1. Field

A deionization apparatus eliminates ion components in a fluid (liquid and gas) and a method controls the same, and, more particularly, a deionization apparatus rapidly and efficiently desorbs ions after the ions are absorbed to electrodes, and a method controls the same.

2. Description of the Related Art

Water and, more particularly, underground water includes a large amount of minerals such as calcium and magnesium. A numerical value representing a total amount of calcium and magnesium is called hardness. Water having high hardness is called hard water, and water having low hardness is called soft water.

If hard water, that is, water having high hardness, is used in an electronic appliance such as a washing machine or a dish washer, detergency deteriorates due to reaction with a detergent. In addition, since a large amount of scales accumulates on a channel in which water flows, the reliability of a product deteriorates.

To solve this problem, a water softener using ion exchange resin has conventionally been suggested.

The water softener using the ion exchange resin softens water while Ca⁺² and Mg⁺² ions, which are hard water components included in the water, are exchanged with Na⁺ obtained from NaCl injected into the ion exchange resin. Such a water softener using the ion exchange resin is disadvantageous in that NaCl should be periodically injected, and the ion exchange resin should be replaced due to impurities included in the water. Since a method of using the ion exchange resin should use an acidic or basic solution when the resin is reproduced and uses a large amount of polymer resin and chemicals to treat a large amount of water, this method is uneconomical.

Recently, to solve this problem, research into a capacitive deionization (hereinafter, referred to as CDI) technology is actively conducted.

The CDI technology is realized based on a simple principle that power is applied to two porous electrodes to electrically absorb negative ions to a positive electrode, and positive ions to a negative electrode, such that ions included in a fluid such as water are eliminated. In addition, if the absorption of the ions to the electrodes is saturated, the polarities of the electrodes are reversed, or the power is disconnected so that the ions absorbed to the electrodes are detached (desorbed), thereby facilitating the regeneration of the electrodes. Since the CDI technology does not uses a cleaning solution such as an acidic or basic solution as is done in the ion exchange resin method, or a reverse osmosis method for the regeneration of the electrodes, a chemical waste is not secondarily generated. In addition, since corrosion or contamination of the electrodes does not occur, the life span of the electrodes is semi-permanent. Furthermore, since the CDI technology has an energy efficiency that is higher than that of other treatment methods, energy is conserved by a factor of 10 to 20 times that of the other treatment methods.

FIG. 1 is a view showing a structure of a unit cell of a general CDI technology. If a DC power source 20 is supplied to a collector 13 having two parallel electrodes 11 and 12 (carbon electrodes) of the unit cell 10, negative ions are electrically absorbed to the positive electrode 11, and positive ions are electrically absorbed to the negative electrode 12 so that the ions are eliminated in a fluid (liquid and gas).

FIG. 2 is an electrical circuit diagram obtained by modeling the power source connection of FIG. 1. The two parallel electrodes 11 and 12 are modeled by connecting two capacitances C1 and C2 in series. The two capacitances C1 and C2 may be expressed by a capacitance Cp [Cp=C1·C2/(C1+C2)]. Rp denotes the sum of parasitic resistances of a conducting wire, the collector 13 or a contact resistance.

The CDI technology has a treatment capacity that is relatively lower than that of the ion exchange resin method. However, to solve this problem, a CDI stack 100 is configured by connecting several unit cells 10 in parallel, as shown in FIG. 3, such that a large amount of ions that are included in water is absorbed when hard water is introduced. Thus, the amount of soft water treated is increased.

FIG. 4 is an electrical circuit diagram obtained by modeling the power source connection of FIG. 3. Cp1, Cp2, Cp3, . . . denote capacitances of the respective CDI cells 10 and Ct (Ct=Cp1+Cp2+Cp3+ . . . ) denotes a total capacitance of the CDI stack 100 including the several CDI cells 10.

FIG. 5 is an electrical circuit diagram obtained by modeling the power source connection of a conventional CDI apparatus including at least two stacks. Ct1, Ct2, Ct3, . . . denote capacitances of the respective CDI stacks 100 and Cs (Cs=Ct1+Ct2+Ct3+ . . . ) denotes a total capacitance of the CDI apparatus, including the at least two CDI stacks 100.

If the ions are absorbed by the CDI stack 100 of FIG. 4 or the CDI apparatus of FIG. 5 (ion absorption mode), a switch is connected to a node A such that the DC power source 20 is supplied to the CDI cells 10 and the CDI stacks 100. While Cp, Ct and Cs are charged, the ions are absorbed to the electrodes 11 and 12 when hard water is introduced. Thus, the water is softened. In contrast, if the ions are desorbed (ion desorption mode), the switch is connected to a node B. Then, while Cp, Ct and Cs charged by the voltage of the DC power source 20 are discharged via Rp, the ions absorbed to the electrodes 11 and 12 are desorbed and are discharged together with the water. Thus, the electrodes 11 and 12 are regenerated.

If the switch is connected to the node B in the ion desorption mode, Cp, Ct and Cs are discharged via Rp. At this time, a discharging voltage Vc(t) is calculated by Equation 1.

Vc(t)=Vi·e−t/τ Equation 1

where, Vc(t) denotes a discharging voltage according to a time t, Vi denotes an initial charging voltage, Rp denotes a resistance component, Cs denotes a total capacitance of the CDI apparatus, e denotes 2.718928, and τ denotes a time constant (Rp·Cs).

As the number of the CDI cells 10 or the CDI stacks 100 is increased, the total capacitance Cs which is the total sum of the capacitances electrically connected in parallel is increased (Cs1<Cs2<Cs3). In addition, as the treatment capacity is increased, a discharging time is increased as shown in FIG. 6. Thus, in the CDI apparatus, a time consumed for desorbing the ions after absorbing the ions to the electrodes 11 and 12 is increased. If the ion desorption time is increased, the amount of water which should be discharged is increased, and thus the waste of the water is increased. Accordingly, there is a need for a CDI apparatus that minimizes the waste of the water while increasing the treatment capacity.

### SUMMARY

Therefore, it is an aspect of the invention to provide an electrical configuration to rapidly and efficiently desorb ions absorbed to electrodes in a CDI apparatus, including at least two stacks, and to provide a regeneration method thereof.

Additional aspects and/or advantages of the invention will be set forth in part in the description which follows and, in part, will be apparent from the description, or may be learned by practice of the invention.

In accordance with the invention, the above and/or other aspects may be achieved by the provision of a deionization apparatus including: a plurality of stacks including electrodes to which ions included in a fluid are absorbed; a circuit unit to connect at least a portion of the plurality of stacks in parallel or in series; and a switch unit to switch at least the portion of the plurality of stacks to a serial connection or a parallel connection.

The switch unit may be controlled to connect the plurality of stacks in parallel in an ion absorption mode and may be controlled to connect at least the portion of the plurality of stacks in series in an ion desorption mode.

The deionization apparatus may further include a power source unit to supply power to the plurality of stacks, and the switch unit may further include a switch to switch power source lines connected between the power source and the plurality of stacks.

The switch unit may be controlled to supply the power to the plurality of stacks in the ion absorption mode and may be controlled to disconnect the power from the plurality of stacks in the ion desorption mode.

The switch unit may be controlled to connect the plurality of stacks in series in the ion desorption mode and may be controlled to connect a portion of the plurality of stacks in parallel and connect the remaining portion of the plurality of stacks in series, in the ion absorption mode.

Each of the stacks may be obtained by connecting a plurality of cells including the electrodes and may further include a circuit unit to connect at least a portion of the plurality of cells in parallel or in series, and the switch unit may further include a switch to switch at least a portion of the plurality of cells to the serial connection or the parallel connection.

The switch unit may be controlled to connect the plurality of cells in parallel in the ion absorption mode and may be controlled to connect the plurality of cells in series in the ion desorption mode.

The switch unit may be controlled to connect the plurality of cells in series in the ion desorption mode.

The switch unit may be controlled to connect a portion of the plurality of cells in parallel and connect the remaining portion of the plurality of cells in series, in the ion absorption mode.

In accordance with an aspect of the invention, there is provided a deionization apparatus including: a plurality of cells including electrodes to which ions included in a fluid are absorbed; a circuit unit to connect at least a portion of the plurality of cells in parallel or in series; and a switch unit to switch at least the portion of the plurality of cells to a serial connection or a parallel connection.

The switch unit may be controlled to connect the plurality of cells in parallel in an ion absorption mode and may be controlled to connect the plurality of cells in series in an ion desorption mode.

The switch unit may be controlled to connect the plurality of cells in series in the ion desorption mode.

The switch unit may be controlled to connect a portion of the plurality of cells in parallel and connect the remaining portion of the plurality of cells in series, in the ion absorption mode.

In accordance with another aspect of the invention, there is provided a method of controlling a deionization apparatus including a plurality of stacks, the method including: connecting the plurality of stacks in parallel in an ion absorption mode; and connecting at least a portion of the plurality of stacks in series in an ion desorption mode.

In accordance with another aspect of the invention, there is provided a method of controlling a deionization apparatus including a plurality of cells, the method including: connecting the plurality of cells in parallel in an ion absorption mode; and connecting at least a portion of the plurality of cells in series in an ion desorption mode.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing an embodiment of a structure of a unit cell of a general CDI technology;

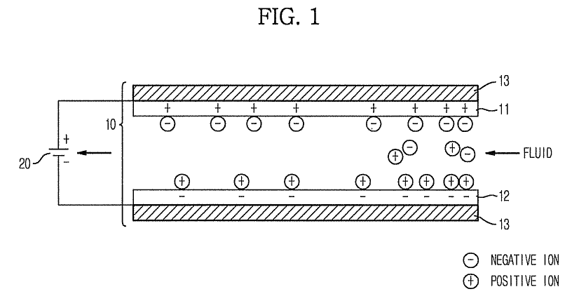

FIG. 2 illustrates an embodiment of an electrical circuit diagram obtained by modeling a power source connection of FIG. 1;

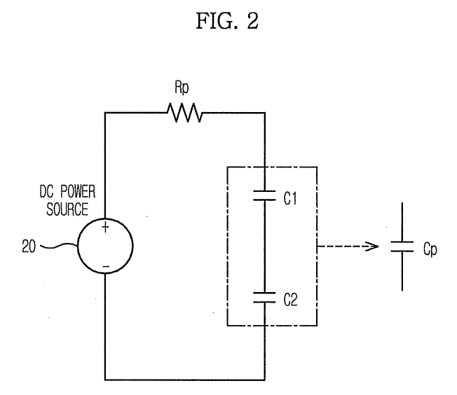

FIG. 3 is a view showing an embodiment of a structure of a CDI stack obtained by connecting several unit cells of FIG. 1;

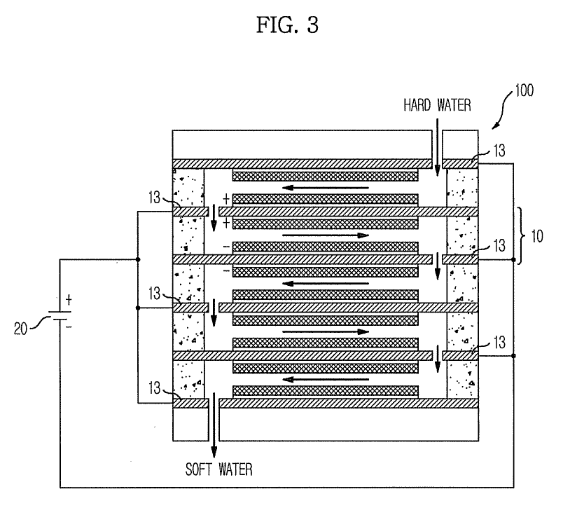

FIG. 4 is an electrical circuit diagram obtained by modeling a power source connection of FIG. 3;

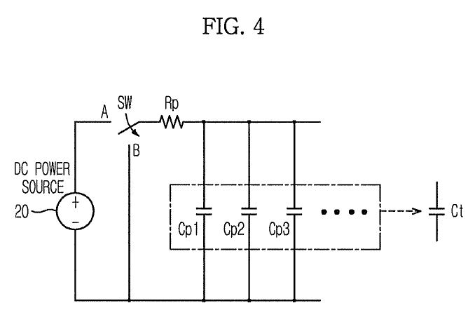

FIG. 5 is an electrical circuit diagram obtained by modeling a power source connection of a conventional CDI apparatus;

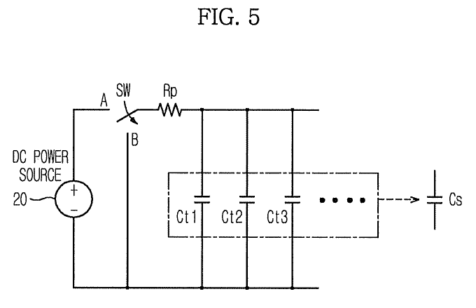

FIG. 6 is a graph showing a discharging time according to a total capacitance Cs of the conventional CDI apparatus;

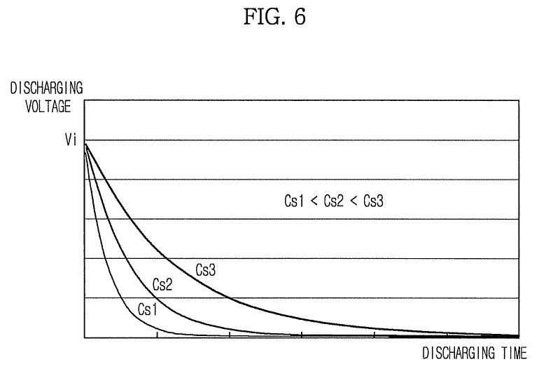

FIG. 7 is an electrical circuit diagram obtained by modeling a power source connection of a CDI apparatus according to an embodiment of the present invention;

FIG. 8 is a table showing switch operations according to modes of the CDI apparatus according to an embodiment of the present invention;

FIG. 9 is an electrical circuit diagram of a power source connection state in an ion absorption mode of the CDI apparatus according to an embodiment of the present invention;

FIG. 10 is an electrical circuit diagram of a power source connection state in an ion desorption mode of the CDI apparatus according to an embodiment of the present invention;

FIG. 11 is an electrical circuit diagram obtained by modeling a power source connection of a conventional CDI apparatus including two stacks;

FIG. 12 is an electrical circuit diagram obtained by modeling a power source connection of a CDI apparatus including two stacks, according to an embodiment of the present invention;

FIG. 13 is a graph showing a difference between discharging times according to discharging voltages of the CDI apparatus according to an embodiment of the present invention and the conventional CDI apparatus;

FIG. 14 is a graph showing a difference between discharging times according to conductivities of the CDI apparatus according to a first embodiment of the present invention and the conventional CDI apparatus;

FIG. 15 is an electrical circuit diagram obtained by modeling a power source connection of a CDI apparatus including six stacks, according to another embodiment of the present invention; and

FIG. 16 is a table showing switch operations according to modes of the CDI apparatus according to another embodiment of the present invention.

### DETAILED DESCRIPTION OF EMBODIMENTS

Reference will now be made in detail to embodiments of the invention, examples of which are illustrated in the accompanying drawings, wherein like reference numerals refer to the like elements throughout. The embodiments are described below to explain the invention by referring to the figures.

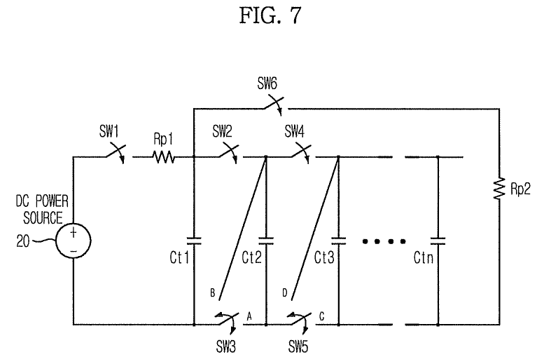

FIG. 7 is an electrical circuit diagram obtained by modeling a power source connection of a CDI apparatus according to an embodiment of the invention. The same portions as the conventional portions are denoted by the same reference numerals.

In the CDI apparatus according to an embodiment of the invention of FIG. 7, n CDI stacks 100 are connected. Ct1, Ct2, Ct3, . . . denote capacitances of the respective CDI stacks 100, Rp1 and Rp2 denote the sum of parasitic resistances, and SW1 to SW6 denote switches to switch the power source connection of the CDI apparatus in an ion absorption mode and an ion desorption mode.

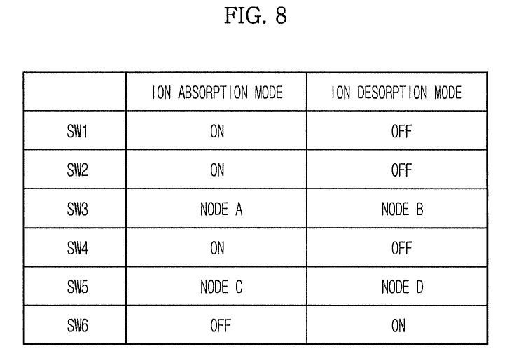

FIG. 8 is a table showing switch operations according to modes of the CDI apparatus according to an embodiment of the invention. The operations of the switches SW1 to SW6 are switched according to the ion absorption mode and the ion desorption mode and the power source of the CDI apparatus is connected according to the modes.

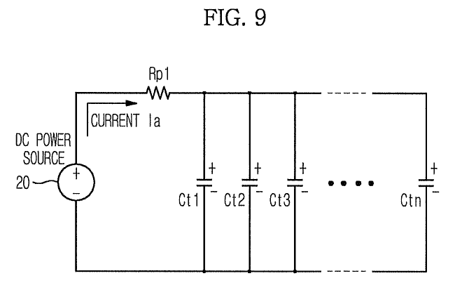

FIG. 9 is an electrical circuit diagram of a power source connection state in the ion absorption mode of the CDI apparatus according to an embodiment of the invention. The capacitances Ct1, Ct2, Ct3, . . . , and Ctn corresponding to the respective CDI stacks 100 are connected in parallel according to the operations of the switches SW1 to SW6 in the ion absorption mode shown in FIG. 8, such that the total capacitance Cs (Cs=Ct1+Ct2+Ct3 . . . +Cn) of the CDI apparatus is increased.

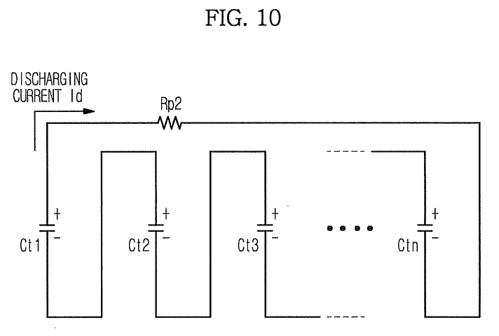

FIG. 10 is an electrical circuit diagram of a power source connection state in an ion desorption mode of the CDI apparatus according to an embodiment of the invention. The capacitances Ct1, Ct2, Ct3, . . . , and Ctn corresponding to the respective CDI stacks 100 are switched from a parallel connection to a serial connection according to the operations of the switches SW1 to SW6 in the ion desorption mode shown in FIG. 8 such that the total capacitance Cs (1/Cs=1/Ct1+1/Ct2+1/Ct3 . . . +1/Cn) of the CDI apparatus is decreased.

Accordingly, since a discharging time to reduce the voltage applied to the CDI stacks 100 to 0V is shortened, the ions absorbed to the ions 11 and 12 are rapidly and efficiently desorbed to rapidly regenerate the electrodes 11 and 12. Accordingly, it is possible to suppress the waste of water by the shortened discharging time.

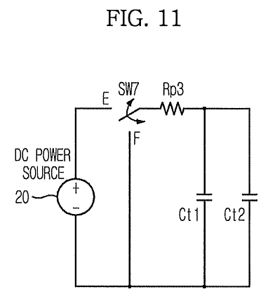

In the CDI apparatus according to an embodiment of the invention, as the number of CDI stacks 100 is increased and treatment capacity is increased, the regeneration effect is more rapidly obtained. FIGS. 11 to 13 show a difference between the invention and the conventional technology in the CDI apparatus including two CDI stacks 100.

FIG. 11 is an electrical circuit diagram obtained by modeling a power source connection of a conventional CDI apparatus including two stacks. In the ion absorption mode, a switch SW7 is connected to a node E such that the DC power source 20 is supplied to two CDI stacks 100. While the capacitance Ct1 and Ct2 corresponding to the two CDI stacks 100 are charged, ions are absorbed to the electrodes 11 and 12 when hard water is introduced. Thus, the water is softened. In contrast, in the ion desorption mode (electrode regeneration), the switch SW7 is connected to a node F, while Ct1 and Ct2 charged by the voltage of the DC power source 20 are discharged via Rp3, the ions absorbed to the electrodes 11 and 12 are desorbed and are discharged together with the water. Thus, the electrodes 11 and 12 are regenerated. When the electrodes 11 and 12 are regenerated, Ct1 and Ct2 are connected in parallel, and thus the total capacitance Cs (Cs=Ct1+Ct2) of the CDI apparatus is increased.

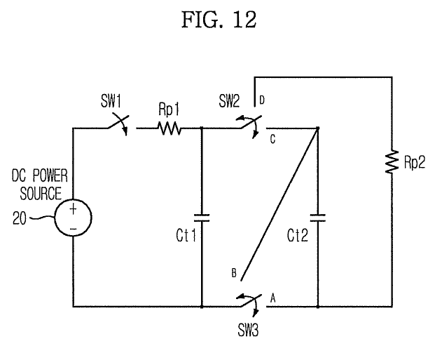

FIG. 12 is an electrical circuit diagram obtained by modeling a power source connection of a CDI apparatus including two stacks, according to a first embodiment of the present invention. In the ion absorption mode, the switch SW1 is turned on, the switch SW2 is connected to a node C and the switch SW3 is connected to a node A, such that the DC power source 20 is supplied to the two CDI stacks 100. Then, while Ct1 and Ct2 are charged, ions are absorbed to the electrodes 11 and 12 when hard water is introduced. Thus, the water is softened. In contrast, in the ion desorption mode (electrode regeneration), the switch SW1 is turned off, the switch SW2 is connected to a node D and the switch SW3 is connected to a node B. Accordingly, while Ct1 and Ct2 charged by the voltage of the DC power source 20 are discharged via Rp3, the ions absorbed to the electrodes 11 and 12 are desorbed and are discharged together with water. Thus, the electrodes 11 and 12 are regenerated. When the electrodes 11 and 12 are regenerated, Ct1 and Ct2 are connected in series, and thus the total capacitance Cs (1/Cs=1/Ct1+1/Ct2) of the CDI apparatus is decreased.

In FIGS. 11 and 12, if it is assumed that Rp1=Rp2=Rp3, Ct1=Ct2, the initial charging voltages of the CDI stacks are Vi to simplify the equation, the total capacitance Cs of the conventional CDI apparatus shown in FIG. 11 becomes 2*Ct1, and the total capacitance of the CDI apparatus according to an embodiment of the invention shown in FIG. 12 becomes Ct1/2.

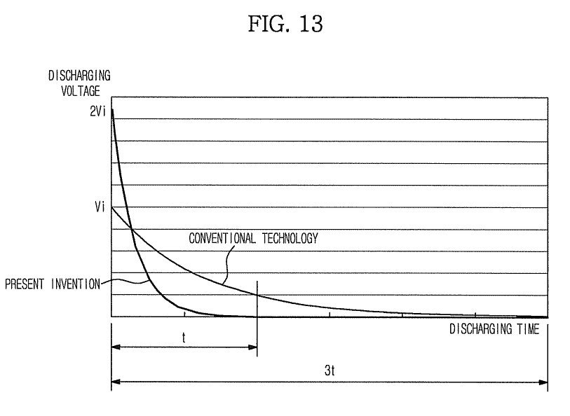

Accordingly, the discharging time to reduce the voltage to 0 V by Equation 1 is shown in FIG. 13.

Vc(t)=Vi·e−t/τ Equation 1

where, Vc(t) denotes a discharging voltage according to a time t, Vi denotes an initial charging voltage, Rp (Rp1, Rp2 and Rp3) denotes a resistance component, Cs denotes a total capacitance of the CDI apparatus, e denotes 2.718928, and τ denotes a time constant (Rp·Cs).

FIG. 13 is a graph showing a difference between discharging times according to discharging voltages of the CDI apparatus according to an embodiment of the invention and the conventional CDI apparatus.

In FIG. 13, when the electrodes 11 and 12 are regenerated, the voltage Vi charged in the two CDI stacks 100 is reduced to 0 V with time. It may be seen that the time to reduce the voltage to 0 V in the conventional regeneration method shown in FIG. 11 is about three times that in the regeneration method according to an embodiment of the invention shown in FIG. 12. As the number of CDI stacks 100 is increased, the total capacitance Cs of the conventional regeneration method shown in FIG. 11 is gradually increased to n*Ct1 by the number of CDI stacks 100. However, the total capacitance Cs of the regeneration method according to an embodiment of the invention is gradually decreased to Ct1/n by the number of CDI stacks 100. Accordingly, while the discharging time may be gradually decreased, the ions absorbed to the electrodes 11 and 12 may be rapidly and efficiently desorbed. If the ion desorption time is decreased, the amount of water to be discharged is decreased, and thus, the waste of the water is decreased. Therefore, it is possible to realize a CDI apparatus that minimizes the waste of water while increasing treatment capacity.

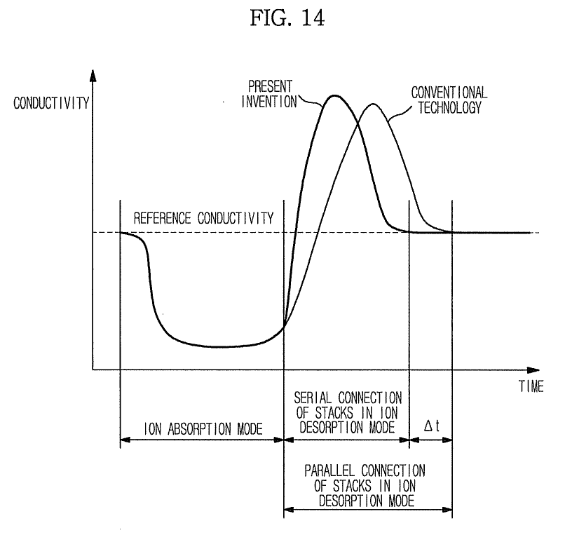

In a CDI water treatment apparatus according to an embodiment of the invention, the effect of the reduction of a regeneration time consumed for desorbing the ions absorbed to the electrodes 11 and 12 after absorbing the ions and sending soft water to a place where the soft water is used is shown in FIG. 14.

FIG. 14 is a graph showing a difference between discharging times according to conductivities of the CDI apparatus according to an embodiment of the invention and the conventional CDI apparatus.

In FIG. 14, when the DC power source 20 is applied to the two parallel electrodes 11 and 12 when water flows into the CDI apparatus at a predetermined flow rate (A Liter/min), ions included in hard water are absorbed to the electrodes 11 and 12 by the capacitances of the two electrodes 11 and 12 and soft water is discharged to the place where the soft water is used while the conductivity is reduced. In the ion desorption mode, 0 V (short circuit) is applied before the ions are saturated in the electrodes 11 and 12, energy charged in the CDI stacks 100 is discharged, and the ions absorbed to the electrodes 11 and 12 are desorbed and are discharged to a water distribution side together with water. At this time, the faster the energy charged in the CDI stacks 100 is discharged, the faster the ions are desorbed from the electrodes 11 and 12. Accordingly, the discharging time is significantly important. It may be seen that the electrode regeneration time may be shortened by Δt due to the technical difference between the CDI apparatus according to an embodiment of the present invention and the conventional CDI apparatus. If Δt is B min, since the flow rate is A Liter/min, A*B liters of water is conserved during one cycle of the CDI apparatus. If a total of 1000 cycles are operated, a total of 1000*A*B liters of water can be conserved.

Accordingly, in the CDI apparatus according to an embodiment of the invention, as the number of CDI stacks 100 is increased, and the treatment capacity is increased, the electrode regeneration time is decreased. Accordingly, a large amount of water may be conserved.

Hereinafter, another embodiment of the invention will be described.

In the CDI apparatus according to an embodiment of the invention, since the initial charging voltage Vi may be increased by connecting the CDI stacks 100 in series, an electrical configuration to connect at least two CDI stacks 100 in series or in parallel may be utilized.

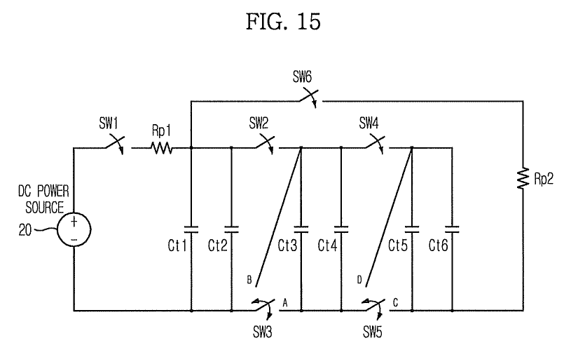

FIG. 15 is an electrical circuit diagram obtained by modeling a power source connection of a CDI apparatus including six stacks, according to an embodiment of the invention. Ct1, Ct2, Ct3, Ct4, Ct5 and Ct6 denotes capacitances of the six CDI stacks 100, Rp1 and Rp2 denote the sum of parasitic resistances, and SW1 to SW6 denote switches to switch the power source connection of the CDI apparatus in the ion absorption mode and the ion desorption mode.

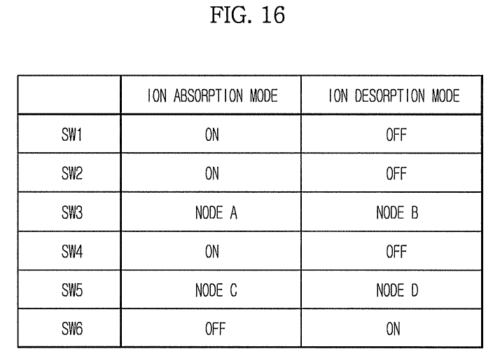

FIG. 16 is a table showing switch operations according to modes of the CDI apparatus according to an embodiment of the invention. The operations of the switches SW1 to SW6 are switched according to the ion absorption mode and the ion desorption mode, and the power source of the CDI apparatus is connected according to the modes.

In the CDI apparatus of FIG. 15, in the ion absorption mode, the switches SW1, SW2 and SW4 are turned on, the switch SW3 is connected to a node A, the switch SW5 is connected to a node C, and the switch SW6 is turned off such that the DC power source 20 is supplied to the six CDI stacks 100. Then, while Ct1, Ct2, Ct3, Ct4, Ct5 and Ct6 are charged, ions are absorbed to the electrodes 11 and 12 when hard water is introduced. Thus, the water is softened. In contrast, in the ion desorption mode (electrode regeneration), the switches SW1, SW2 and SW4 are turned off, the switch SW3 is connected to a node B, the switch SW5 is connected to a node D, and the switch SW6 is turned on. Accordingly, while Ct1, Ct2, Ct3, Ct4, Ct5 and Ct6 charged by the voltage of the DC power source 20 are discharged via Rp2, the ions absorbed to the electrodes 11 and 12 are desorbed and are discharged together with water. Thus, the electrodes 11 and 12 are regenerated. When the electrodes 11 and 12 are regenerated, Ct1, Ct2, Ct3, Ct4, Ct5 and Ct6 are connected in series and in parallel, and thus the total capacitance Cs (1/Cs=1/(Ct1+Ct2)+1/(Ct3+Ct4)+1/(Ct5+Ct6)) of the CDI apparatus is decreased compared with the total capacitance (Cs=Ct1+Ct2+Ct3+Ct4+Ct5+Ct6) when the stacks are connected in parallel. In addition, the initial charging voltage Vi may be decreased compared with the case where the stacks 100 are connected in series.

Although a portion of the stacks 100 is connected in parallel in FIG. 15, the stacks 100 may be changed to the serial connection or the parallel connection as shown in FIG. 7. Alternatively, a portion of the stacks 100 may be connected in parallel and the remaining portion of the stacks may be connected in series.

Although the plurality of stacks 100 is switched between the serial connection and the parallel connection in an embodiment of the invention, the invention is applicable to a circuit to connect a plurality of cells 10 configuring one stack 100 or is simultaneously applicable to a circuit to connect a plurality of cells 10 in one stack 100 and a circuit to connect a plurality of stacks 100.

Although a few embodiments of the invention have been shown and described, it would be appreciated by those skilled in the art that changes may be made in these embodiments without departing from the principles and spirit of the invention, the scope of which is defined in the claims and their equivalents.

What is claimed is:

1. A deionization apparatus comprising:
a plurality of stacks including electrodes to which ions included in a fluid are absorbed;
a circuit unit to connect at least a portion of the plurality of stacks in parallel or in series; and
a switch unit to switch the at least the portion of the plurality of stacks to a serial connection or a parallel connection.

2. The deionization apparatus according to claim 1, wherein the switch unit is controlled to connect the plurality of stacks in parallel in an ion absorption mode and is controlled to connect the at least the portion of the plurality of stacks in series in an ion desorption mode.

3. The deionization apparatus according to claim 1, further comprising a power source unit to supply power to the plurality of stacks,
wherein the switch unit further includes a switch to switch power source lines connected between the power source and the plurality of stacks.

4. The deionization apparatus according to claim 3, wherein the switch unit is controlled to supply the power to the plurality of stacks in the ion absorption mode and is controlled to disconnect the power from the plurality of stacks in the ion desorption mode.

5. The deionization apparatus according to claim 2, wherein the switch unit is controlled to connect the plurality of stacks in series in the ion desorption mode.

6. The deionization apparatus according to claim 2, wherein the switch unit is controlled to connect a portion of the plurality of stacks in parallel and connect a remaining portion of the plurality of stacks in series, in the ion absorption mode.

7. The deionization apparatus according to claim 1, wherein:
each of the stacks is obtained by connecting a plurality of cells including the electrodes and further includes a circuit unit to connect at least a portion of the plurality of cells in parallel or in series, and
the switch unit further includes a switch to switch the at least the portion of the plurality of cells to the serial connection or the parallel connection.

8. The deionization apparatus according to claim 7, wherein the switch unit is controlled to connect the plurality of cells in parallel in the ion absorption mode and is controlled to connect the plurality of cells in series in the ion desorption mode.

9. The deionization apparatus according to claim 8, wherein the switch unit is controlled to connect the plurality of cells in series in the ion desorption mode.

10. The deionization apparatus according to claim 8, wherein the switch unit is controlled to connect a portion of the plurality of cells in parallel and connect a remaining portion of the plurality of cells in series, in the ion absorption mode.

11. A deionization apparatus comprising:
a plurality of cells including electrodes to which ions included in a fluid are absorbed;
a circuit unit to connect at least a portion of the plurality of cells in parallel or in series; and
a switch unit to switch the at least the portion of the plurality of cells to a serial connection or a parallel connection.

12. The deionization apparatus according to claim 11, wherein the switch unit is controlled to connect the plurality of cells in parallel in an ion absorption mode and is controlled to connect the plurality of cells in series in an ion desorption mode.

13. The deionization apparatus according to claim 12, wherein the switch unit is controlled to connect the plurality of cells in series in the ion desorption mode.

14. The deionization apparatus according to claim 12, wherein the switch unit is controlled to connect a portion of the plurality of cells in parallel and connect a remaining portion of the plurality of cells in series, in the ion absorption mode.

15. A method of controlling a deionization apparatus including a plurality of stacks, the method comprising:
connecting the plurality of stacks in parallel in an ion absorption mode; and
connecting at least a portion of the plurality of stacks in series in an ion desorption mode.

16. A method of controlling a deionization apparatus including a plurality of cells, the method comprising:
connecting the plurality of cells in parallel in an ion absorption mode; and
connecting at least a portion of the plurality of cells in series in an ion desorption mode.

17. A deionization apparatus comprising:
a plurality of stacks, wherein the stacks are switchably arranged for parallel or series connection, including electrodes to which ions included in a fluid are absorbed; and
a circuit unit to connect at least a portion of the plurality of stacks in parallel or in series.

18. The deionization apparatus according to claim 17, further comprising:
a switch unit to switch the at least the portion of the plurality of stacks to a serial connection or a parallel connection.

19. The deionization apparatus according to claim 18, wherein the switch unit is controlled to connect the plurality of stacks in parallel in an ion absorption mode and is controlled to connect the at least the portion of the plurality of stacks in series in an ion desorption mode.

20. The deionization apparatus according to claim 18, further comprising a power source unit to supply power to the plurality of stacks,
wherein the switch unit further includes a switch to switch power source lines connected between the power source and the plurality of stacks.
